(19) United States
(12) Patent Application Publication
(10) Pub. No.: US 2002/0095473 A1
(43) Pub. Date: Jul. 18, 2002

(54) Home-based client-side media computer

(76) Inventors: Stuart Berkowitz, Toronto (CA); Liang Shen, North York (CA)

Correspondence Address: Jones, Day, Reavis & Pogue, North Point, 901 Lakeside Avenue, Cleveland, OH, 44114, US

(21) Appl. No.: 09/760,028

(22) Filed: Jan. 12, 2001

(51) Int. Cl. G06F 15/16; G05B 11/01

(52) U.S. Cl. 709/217; 700/17

(57) ABSTRACT

A home-based client-side media computer for use within a home that has a broadband connection to an Internet network. The home computer includes a first connection port to allow a speech-based conversation to occur over the home-based broadband connection to the Internet network. A second connection port is included to allow a speech-based conversation to occur over a public switched telephone network (PSTN). A plurality of speech engines recognize and synthesize speech to allow the speech-based conversations to occur over the first connection port and the second connection port.

### BACKGROUND

1. Technical Field

The present invention is directed to Internet-based voice systems. More specifically, the present invention is directed to Internet-based voice systems that are used within a home or SOHO (small office/home office) environment.

2. Description of Related Art

The Internet provides many services to computer users. A rapidly growing service is the ability to make telephone calls and send faxes over Internet networks. This Internet service stands as a direct competitor to telephone connections that are over PSTNs (public switched telephone networks).

Internet servers that are remote from the users' home computers provide the software and hardware infrastructure for placing telephone calls over Internet networks. The need to use remote Internet servers for placing the telephone calls has disadvantages. An exemplary disadvantage is that accessing remote Internet servers consumes time that makes the Internet telephone call process less efficient.

Moreover, the Internet has continually moved functionality from the client-side home computer to the server-side computer. For example, the details of how to access a remote database have been move from the home client-side to the remote server-side. Thus, a client-side home computer has a web browser (such as Internet Explorer from Microsoft Corp. located in Redmond, Washington) that does not know the access primitives of the remote database system, such as the query languages, operating systems, login, and security aspects of the remote database system.

Accordingly, the trend has been to move the detailed functionality of interacting with remote systems from the client-side home computer to a remote server. Due to this trend, most Internet telephony systems require a “heavy” involvement of remote servers to allow users to utilize Internet telephony. In such systems, users have less control over customizing how the Internet telephone process should be conducted. These disadvantages as well as others render the present systems less efficient and effective to service the needs of users.

### SUMMARY

The present invention solves the aforementioned disadvantages as well as other disadvantages of the present systems. In accordance with the teachings of the present invention, a home-based client-side media computer is provided for use within a home that has a broadband connection to an Internet network. The home computer includes a first connection port to allow a speech-based conversation to occur over the home-based broadband connection to the Internet network. A second connection port is included to allow a speech-based conversation to occur over a public switched telephone network (PSTN). A plurality of speech engines recognize and synthesize speech to allow the speech-based conversations to occur over the first connection port and the second connection port.

### BRIEF DESCRIPTION OF THE DRAWINGS

FIG. 1 is a system block diagram that depicts a home computer that controls home devices in accordance with the teachings of the present invention;

FIG. 2 is a system block diagram that depicts a home computer that controls software applications in accordance with the teachings of the present invention;

FIGS. 3 and 4 are system block diagrams that depict the detailed exemplary computer-implemented components of the present invention;

FIG. 5 is a system block diagram that depicts an audio advertising system used within the present invention;

FIG. 6 is a system block diagram that depicts a voice application web site used within the present invention;

FIG. 7 is a data structure diagram that depicts the taxonomy data structure used by the voice application web site;

FIG. 8 is a flowchart that depicts the operational steps to control home devices and/or software applications through the teachings of the present invention;

FIGS. 9 and 10 are flowcharts that depict the operational steps of the present invention for a user placing a phone call to another person through a PSTN connection and/or Internet connection; and

FIGS. 11-13 are flowcharts that depict the operational steps of the present invention for handling a service request from a user.

### DETAILED DESCRIPTION OF THE PREFERRED EMBODIMENT

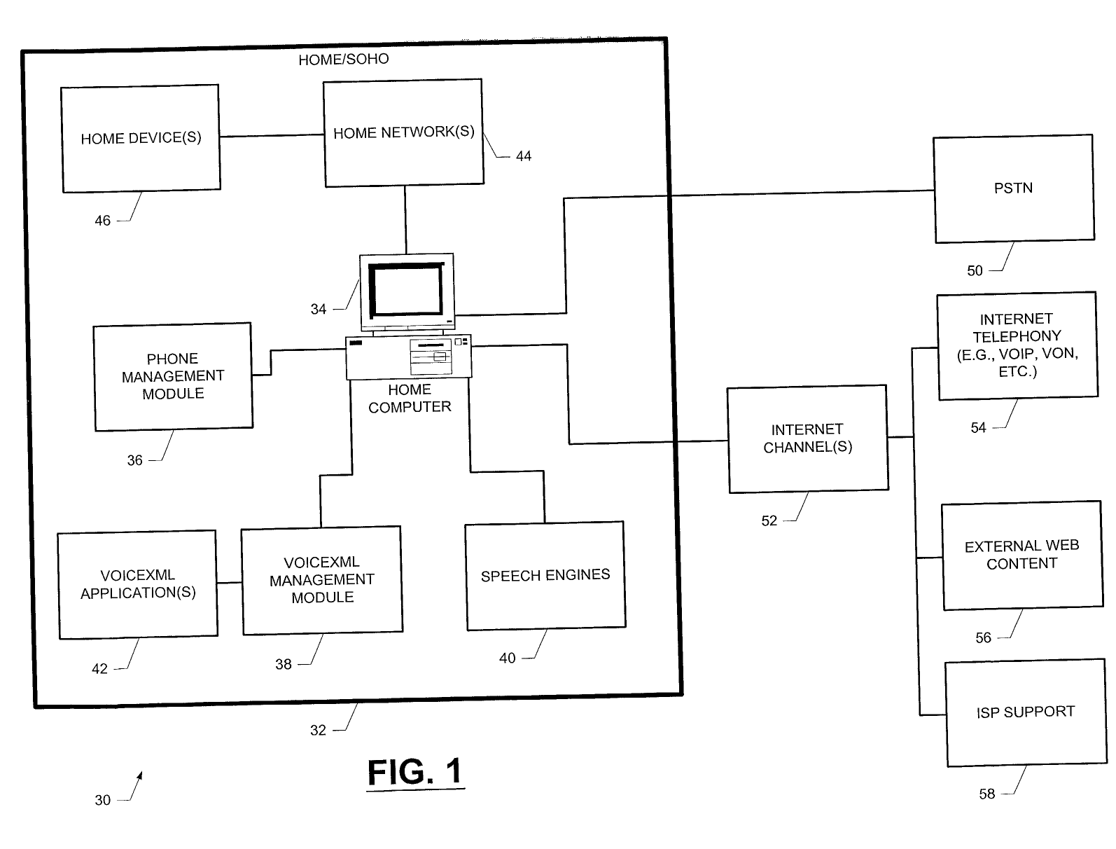

FIG. 1 is a system block diagram that generally shows at 30 the computer-implemented components of the present invention. The present invention allows Internet networks and telephone networks to co-exist at computer 34 within the user's home 32. A user can issue commands to the user's home computer 34 using a speech-based conversation to control home devices 46 (such as appliances) as well as other items. A user may be remotely located from the home 32 and use a plain telephone or a wireless communication device (e.g., a cell phone) to communicate with the home computer 34. Also, the present invention can be used to communicate with another person who may be using a cell phone. It should be understood that the present invention includes any computer that is typically located within a home, such as a Microsoft Windows-based home computer.

The home computer 34 includes a PSTN connection port to receive and/or send calls over a PSTN connection 50. The home computer also includes an Internet connection port to receive and/or send calls over an Internet channel. An embodiment of the present invention includes having a broadband Internet connection that is substantially always available to the home computer 34. However, it should be understood that the present invention includes using any type of Internet connection that can handle voice data.

The home computer 34 includes a phone management module 36 that handles calls from the user. Speech engines 40 recognize the speech and words of the user. Many companies, such as Dragon Systems, Inc. located in Burlington, Mass. provide speech recognition engines that may be used with the present invention.

The phone management module 36 determines whether a voice markup language application is needed to provide additional functionality to service a request of a user. An example of a service request is a user calling the home computer 34 so that the user may locate a restaurant in a certain city. An embodiment of the present invention uses a voice markup language known in the speech industry as VoiceXML (Voice Extensible Markup Language). A VoiceXML management module 38 handles the VoiceXML applications 42 that are resident on the home computer 34. The VoiceXML management module 38 determines which VoiceXML application(s) can service the request of the remote user. If a VoiceXML application is not resident on the home computer that is needed to service a request, then the VoiceXML management module 38 communicates over an Internet channel 52 to locate a suitable VoiceXML application. Accordingly, the present invention supplements its functionality with external web content 56.

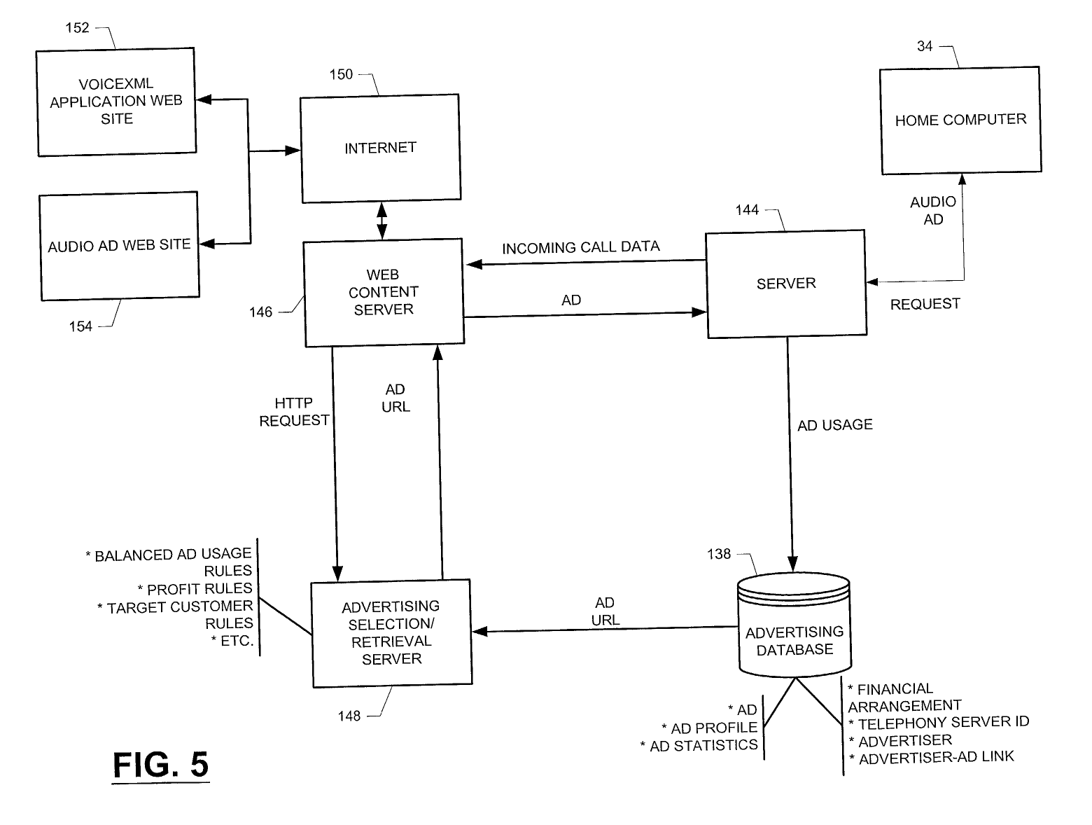

An embodiment of the present invention uses a remote web site to locate suitable VoiceXML applications. The web site may exact compensation for locating the suitable VoiceXML applications by having the user listen to an audio advertisement (FIGS. 5-7 describe below in greater detail the VoiceXML web site application retrieval system and the audio advertising system that are used within the present invention).

With reference to FIG. 1, the user communicates with the home computer to control a home device 46. One or more suitable VoiceXML applications on the home computer 34 allow a speech-based conversation with the user to control the home device 46. The home computer 34 processes commands from the user and transmits the commands to the home device 46 over a home data communication network 44. The home computer 34 also provides status information about the home devices 46, such as whether a particular home appliance is on. In an embodiment of the present invention, an Internet Service Provider (ISP) 58 provides support to the home computer 34. Such support includes providing a broadband Internet connection to locate VoiceXML applications.

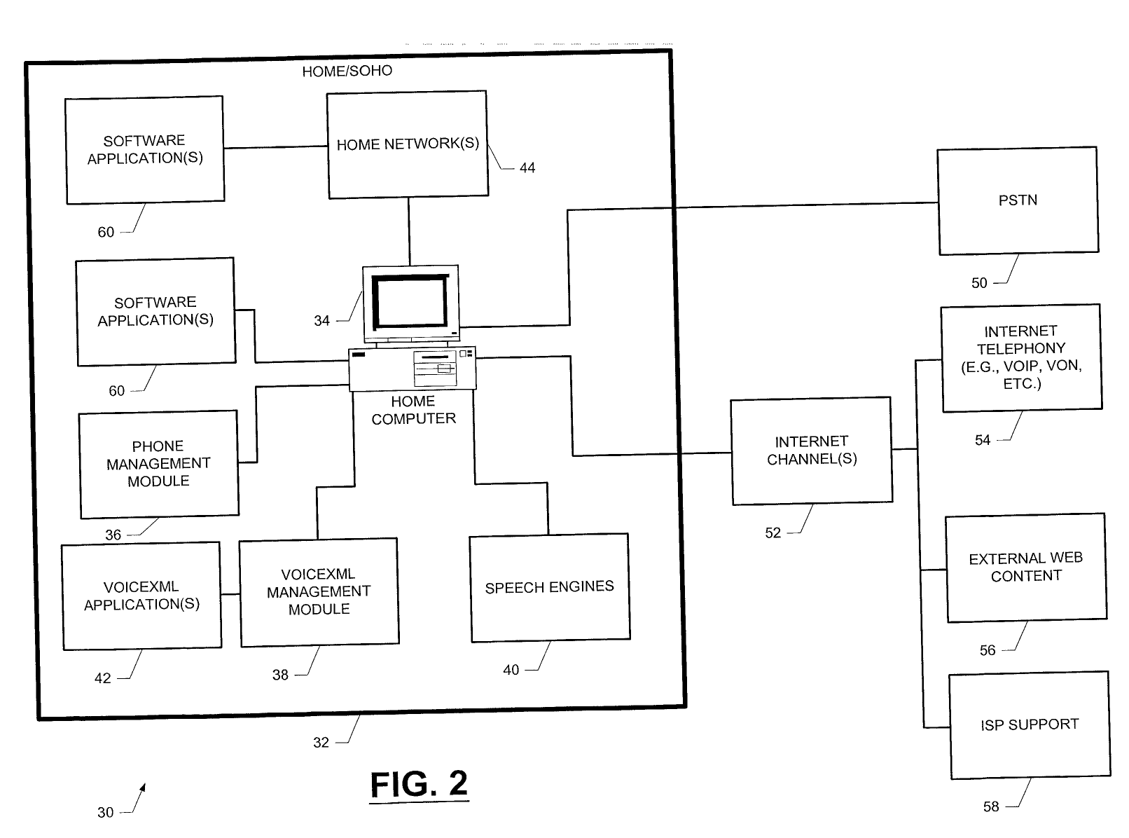

FIG. 2 is a system block diagram that depict the home computer 34 controlling software applications in accordance with the teachings of the present invention. A user may issue commands to the user's home computer 34 using a speech-based conversation to control software applications 60 (such as an address/appointment software application). A user may be remotely located from the home 32 and use a plain telephone or a wireless communication device (e.g., a cell phone) to communicate with the home computer 34 in order to control the software applications 60. The software applications 60 may reside on the home computer 34 or may be located within the home 32 on a computer other than the home computer 34 where they are accessible over the home network 44.

A remote user may use a speech-based conversation to access the address/appointment software application 60 and determine the telephone number of a person the user wishes to call. The home computer using an appropriate VoiceXML application and a speech recognition engine acquires from the user the name of the person whom the user wishes to call. The address/appointment software application located in the home 32 is searched using the recognized name. The search results are spoken to the user using a text-to-speech engine. The user voices an affirmative that the person should be called.

The home computer 34 recognizes the user's voiced affirmative and automatically dials the number of the person. The home computer may select to route the call to the person through an Internet channel 52 or a PSTN connection 50. The home computer 34 may use a Voice Over IP (VoIP) product, a Voice on the Net (VON) product, or other such similar products to place the call over the Internet channel 52. An example of a VoIP product is the VoIP product available from VocalTec Communications Ltd. located in Fort Lee, N.J. An example of a VON product is the VON product available from Intel located in Austin, Texas.

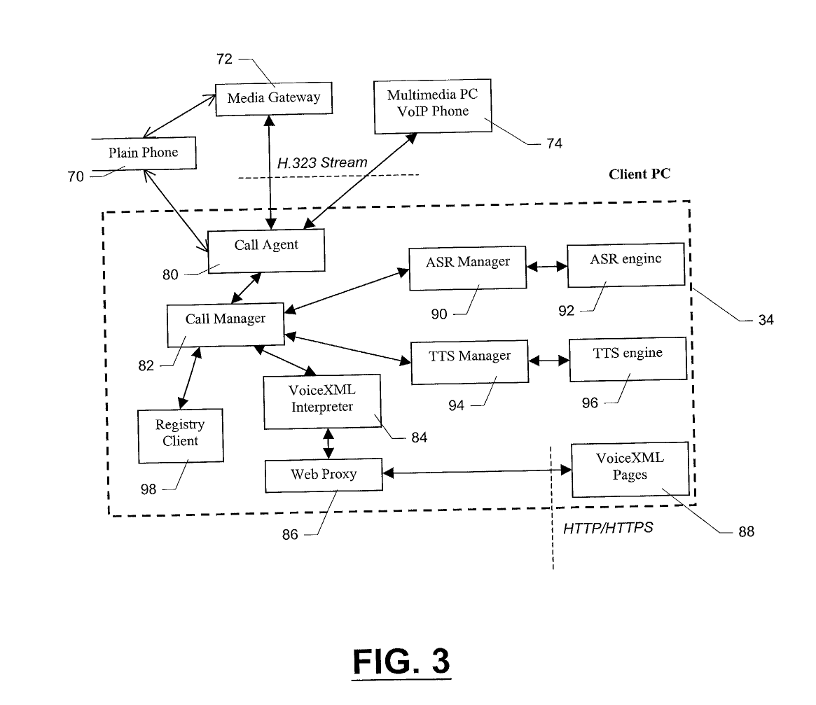

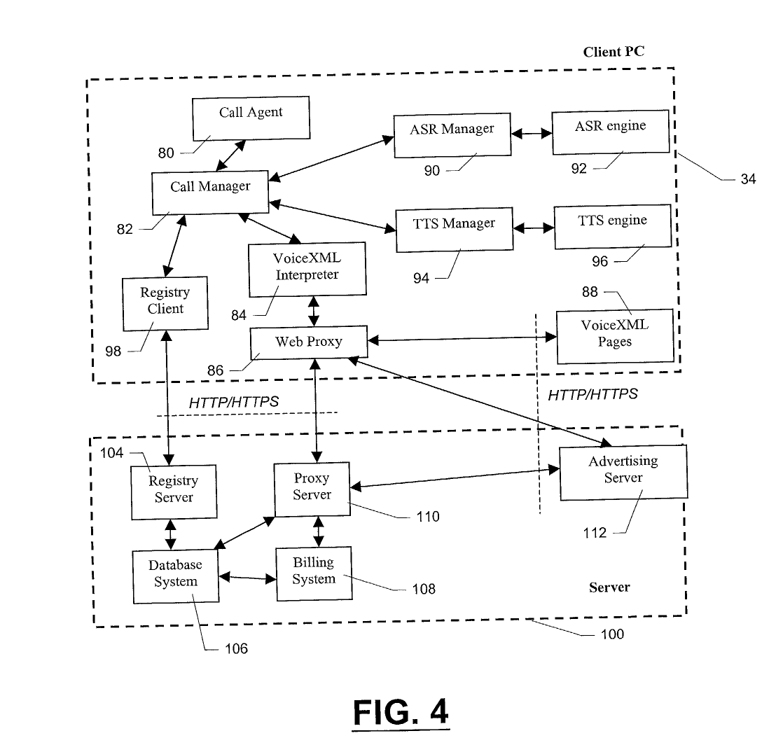

FIGS. 3 and 4 are system block diagrams that depict exemplary detailed computer-implemented components of the present invention. In these diagrams a user is using a plain phone 70 (such as a wireless communication device) to communicate with the home computer 34. The home computer 34 uses a call agent 80 to receive and forward calls from the user. The call agent forwards the call to a call manager 82 which uses automated speech recognition tools to recognize the speech uttered by the user. Preferably, the tools include an automatic speech recognition manager 90 to manage the one or more automatic speech engines 92, as well as a text-to-speech manager 94 to manage the one or more text-to-speech engines 96. Different speech engines are used based upon the application at hand. For example, one type of text-to-speech engine may be used when conversing with the user in French, while another engine is used with another user in English.

If available, the user may communicate with the home computer 34 through an Internet telephone connection which is provided in this embodiment as a media gateway 72. The media gateway 72 communicates with the call agent 80 through a H.323 standard. The H.323 standard is a multimedia-over ISDN standard that has been optimized for packet-based networks, such as TCP/IP. The H.323 standard is also used by the call agent 80 to place calls over an Internet channel, such as one that allows the use of VoIP phone systems 74. It should be understood that the present invention includes using any communication protocol that allows voice data to be communicated over a network.

With reference to FIG. 4, the call manager 82 determines whether a VoiceXML application is needed to service the request of the user. One or more VoiceXML pages (i.e., applications) 88 are obtained and stored in a web proxy 86 located on the home computer 34. The web proxy 86 may retrieve VoiceXML applications over the Internet and cache the VoiceXML applications in order to improve the performance of servicing the user's request. A VoiceXML interpreter 84 on the home computer 34 executes the VoiceXML pages 88 and may utilize one or more speech engines (92, 96) in order to interact with the user.

The web proxy 86 may enlist the assistance of a remote server system 100 in order to obtain needed VoiceXML pages 88. Preferably, the web proxy 86 communicates with the proxy server 110 on the remote server system 100 through an hypertext transfer protocol/hypertext transfer protocol secure (http/https) channel. The proxy server 110 retrieves VoiceXML pages 88 that are needed by the home computer 34.

To compensate the operators of the remote server system 100 for their assistance, the remote server system 100 may use a registry server 104 to identify which home computer 34 is requesting service. A registry client 98 on the home computer 34 provides the needed identification information to the registry server 104 so that the proper home computer 34 may be billed. The remote server system 100 may use a database system 106 to determine additional identification information (such as the billing address for the home computer 34) in order to generate billing data. A billing system 108 formats the generated billing data so that it may be sent to the user of the home computer 34. To further supplement the cost of providing services to the home computer 34, the remote server system 100 may contain an advertising server 112 to provide audio advertisements to the user. FIG. 5 is a system block diagram that depicts an audio advertising system used within the present invention.

With reference to FIG. 5, the advertising selection and retrieval computer system of the present invention ensures delivery of the audio ad to the user. The present invention retrieves audio ads from the advertising database 138 in response to an incoming call from the home computer 34. A user may be using a telephone or a wireless communication device to communicate with the home computer 34 to have a service performed for the user. An example of a service includes the home computer 34 receiving a call from the user so that the user may locate a restaurant in a certain city. The home computer 34 uses the web content server 146 to access a restaurant-locating software application that is on a network, such as the Internet 150. The application may be a VoiceXML application located on a remote web site 152. Another exemplary application includes a user calling to locate the phone number of another individual. In this latter example, the application is a phone number lookup VoiceXML application.

The home computer 34 forwards the incoming call to a server 144 (which may be the server of the ISP) which forwards the call to a web content server 146. The web content server 146 formulates a hypertext transfer protocol (http) request for an audio ad. The request is sent to the advertising selection/retrieval server 148 for processing. The advertising selection/retrieval server 148 selects an appropriate audio ad from the advertising database 138 and sends back an ad location identifier to the web content server 146. The web content server 146 retrieves the audio file from a web site 154 based upon the ad location identifier and dynamically inserts the ad audio file into the VoiceXML application. The web content server sends the VoiceXML application back to the home computer 34 so that the VoiceXML application may be executed. The audio file is also sent so that it may be played for the user of the home computer 34.

The web content server 146 may include in the http request such information as the type of user that is placing the incoming call. The web content server 146 knows what type of user is placing the incoming call based upon information that the user has already provided to the server 144. For example, the server 144 may know where the user is located based upon the area code of the incoming call or the server 144 has a database that stores profiles of its users. The user's request may also furnish additional information. For example, if the user is requesting jewelry information, then the web content server 146 may supplement the http request with that profile information. In such a situation, the advertising selection/retrieval server 148 may heighten the probability that a jewelry-related audio ad be selected. The server 144 may also have asked the user questions about the user's profile.

The advertising selection/retrieval server 148 selects an audio ad based upon certain predetermined rules. The ad selection rules include: balanced ad usage rules, profit rules (e.g., revenue sharing rules), target user/customer profile rules, and other selection rules that will be apparent to one skilled in the art. The balanced ad usage rules ensure that audio ads are played at least a certain amount of times. The profit rules optimize the amount of earnings the operators of the present invention acquire for the playing of the audio ads. For example, the profit rules may indicate that a first audio ad be played more often than a second audio ad when the first audio ad's financial arrangement is based upon a profit-sharing arrangement, and the second audio ad's financial arrangement is a set fee arrangement. The target user profile rules ensure that audio ads that fit a user profile are played. For example, a jewelry-related audio ad is played for a user who has requested jewelry-related information. Examples of other selection rules include accounting information (such as whether the advertiser is current in its payments to the operators), application service provider configuration, and content provider configuration.

The home computer 34 provides ad usage data which is stored in the advertising database. The home computer 34 records how long an audio ad was played to the user. The user may terminate the call before the entire audio ad was played. The ad usage information is sent to advertisers to provide feedback on the quality of their ads. For example, if a certain ad is habitually terminated early by users, then this serves as an indication that the ad may need to be improved or replaced.

The present invention operates with free content providers. In this context, the system of the present invention is entitled to a certain number of minutes (i.e., four minutes) of its own ad for every time slot (e.g., twenty-two minutes) while the application service provider provides a piece of time for its own ad. In other words, for every block of time, say thirty minutes, the content provider can use only twenty-two minutes of that time block while keeping the remaining four minutes for its own ad and four minutes for the application service provider.

The present invention includes a revenue sharing system. The hosting company who owns the advertising servers charges a one time listing fee and monthly platform usage fees from advertising agencies and telephony server operators. The advertising agencies pay the hosting company with the listing fee and monthly platform fee, and pay the server operators (i.e., the ISPs) the ad usage fee.

The server operators pay the hosting company the listing and monthly platform fees and receive the ad usage fees from matched advertisers. The server operators distribute the ad fees with the connected application providers, and charge the application providers the application usage/listing fees.

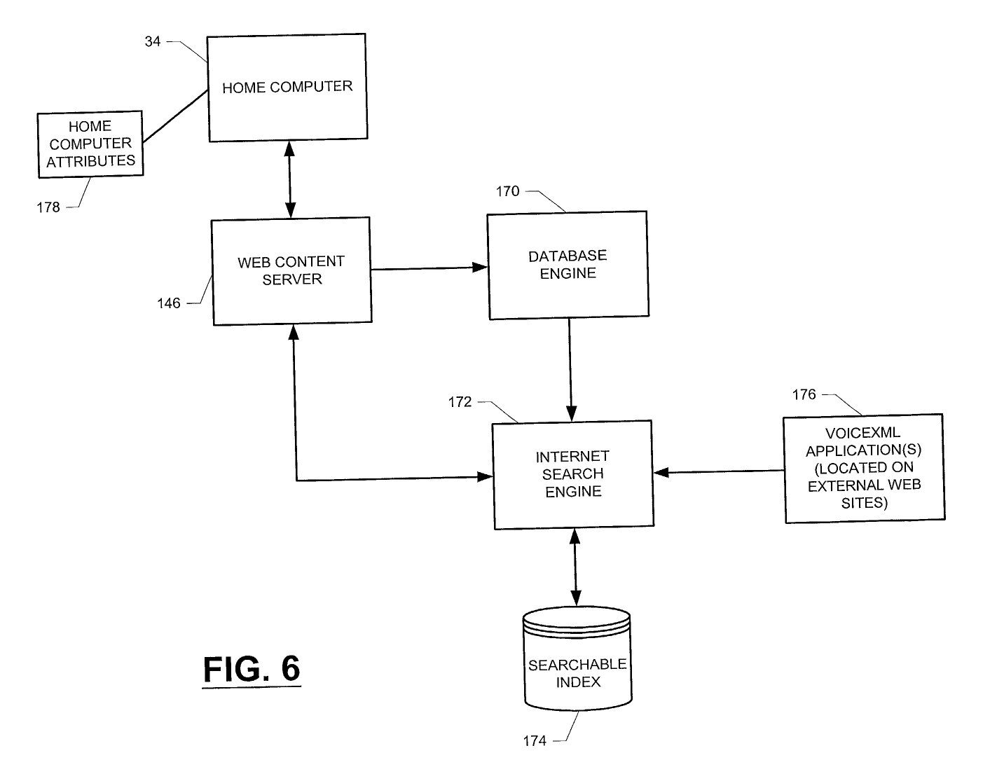

FIG. 6 is a system block diagram that depicts a voice application web site used within the present invention. Voice computer applications, such as VoiceXML applications, are indexed and catalogued. The voice applications are able to be searched using the index and linked into a user's home computer. Once linked, the user has access via a wireless communication device to the services provided by the voice applications.

A user utilizes a communication device to access the user's home computer 34. The present invention may be utilized by many different types of communication devices, such as a cellular communication device. The user may be accessing the home computer 34 to have a service performed. An example of a service includes the home computer 34 receiving a call from the user so that the user may locate a restaurant in a certain city. The home computer 34 uses a web server 146 to access a restaurant-locating voice application 176 that is on a network, such as the Internet. The voice application 176 may be a VoiceXML application located on a remote web site.

The home computer 34 determines that a service is needed in order to process the request from the user. The home computer 34 communicates to the web server 146 the characteristics of the needed service. The web server 146 locates a voice application 176 that can provide the needed service.

The web server 146 communicates to a database engine 170 the characteristics of the needed service. The database engine 170 uses an Internet search engine 172 to search a voice application index database 174. The database 174 contains an index of voice applications that have been catalogued according to a taxonomy of the present invention. For example, the taxonomy includes indexing voice applications based upon what resources are required to operate each voice application.

The database engine 170 formulates search criteria to locate voice applications that can provide the needed service. The search criteria is formulated based upon the characteristics of the needed service. The characteristics include what type of application is needed, such as whether the home computer needs a restaurant-locating voice application or some other voice application type. The search criteria also includes home computer attributes 178. Home computer attributes 178 describe the operating characteristics of the home computer 34, such as what speech engines are able to operate on the home computer 34.

The Internet search engine 172 uses the search criteria to determine which voice applications are suitable to fulfill the home computer's request. When the location of at least one suitable voice application has been identified, the Internet search engine 172 retrieves the suitable voice application 48 over the Internet. The Internet search engine 172 then provides the voice application 48 to the home computer 34 via the web server 146. The home computer 34 performs the functions of the voice application 48 in order to satisfy the request of the user 32.

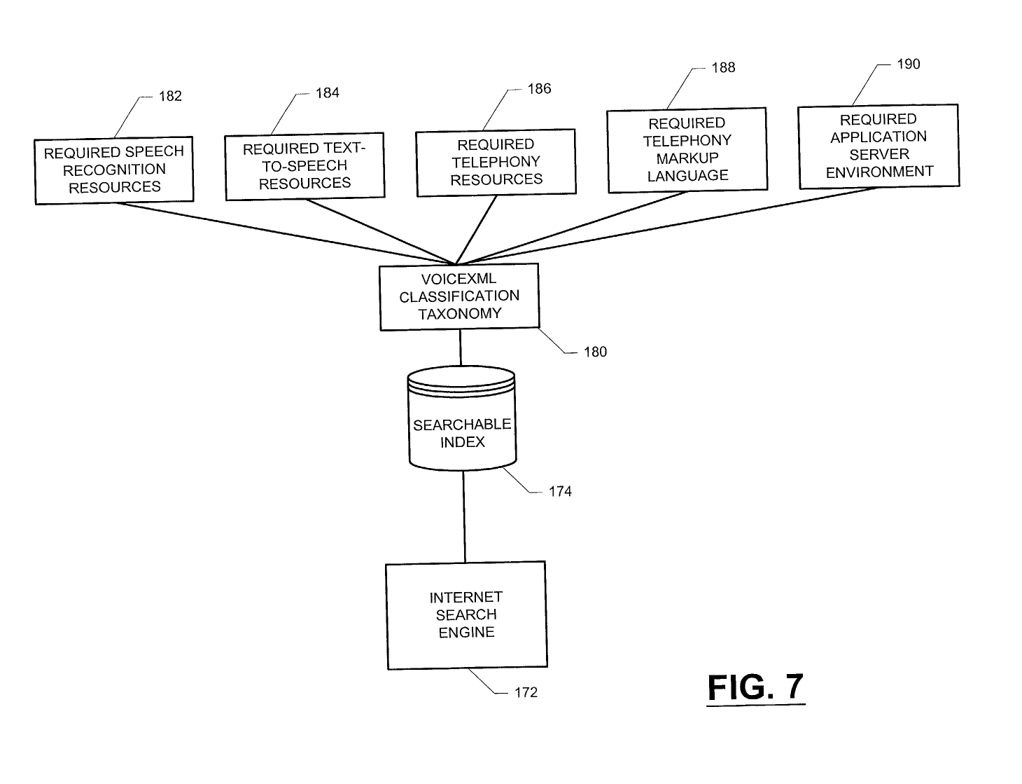

FIG. 7 is a data structure diagram depicting the schema of the searchable index database 174. The index database 174 is structured according to a taxonomy 180 that classifies voice applications. The taxonomy 180 includes: a data structure 182 to store information about speech recognition resources required by the voice applications; a data structure 184 to store information about text-to-speech resources required by the voice applications; a data store 186 to store telephony resources required by the voice applications; a data structure 188 to store the version of the markup languages used by the voice applications; and a data structure 190 to store the application server environment information and licensing information of the voice applications. The server of the index database 174 may be implemented in a relational database. However, it should be understood that the present invention is not limited to a relational database environment, but includes computer information storage schemes that permit the storage and retrieval of the voice application classification data.

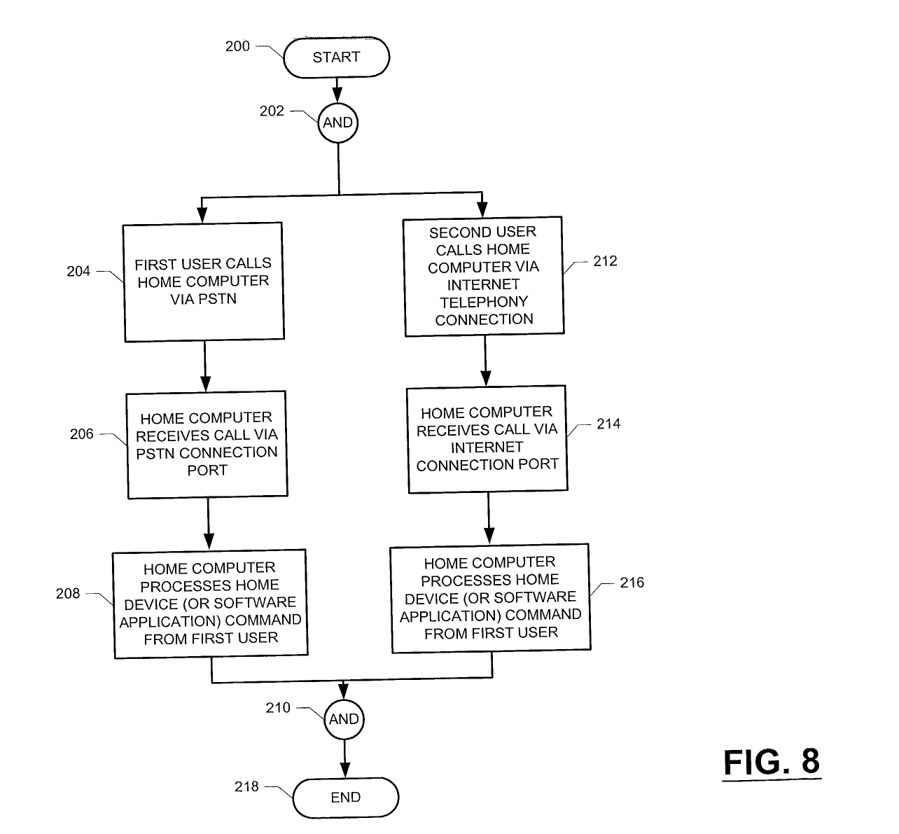

FIG. 8 is a flowchart that depicts the operational steps to control home devices and/or software applications through the present invention. As shown by the start indication block 200, the user may place a call to the user's home computer either through a PSTN connection or an Internet telephony connection. The “AND” indicator symbol 202 indicates that the following processing may occur in parallel. Due to this desired parallel functionality, it is preferable that the home computer is a multi-tasking computer.

If the user calls through a PSTN connection, then process block 204 is first performed. At process block 204, a first user calls the home computer via a PSTN connection. At process block 206, the home computer receives the call via its PSTN connection port. At process block 206, the home computer receives a command from the first user. The command may be any type of command, such as a command to control a home device or a software application. The first user may send as many commands as desired to the home computer, and then terminate processing at end block 218 when finished.

The home computer may also process a call from a second user over its Internet telephony connection port. The home computer may process this call either alone or substantially concurrently with the processing of a call received over its PSTN connection port. At process block 212, a second user calls the home computer, and the home computer receives the call over its Internet telephony connection port at process block 214.

At process block 216, the home computer receives a command from the second user. The command may be any type of command, such as a command to control a home device or a software application. The second user may send as many commands as desired to the home computer, and then terminate processing at end block 218 when finished.

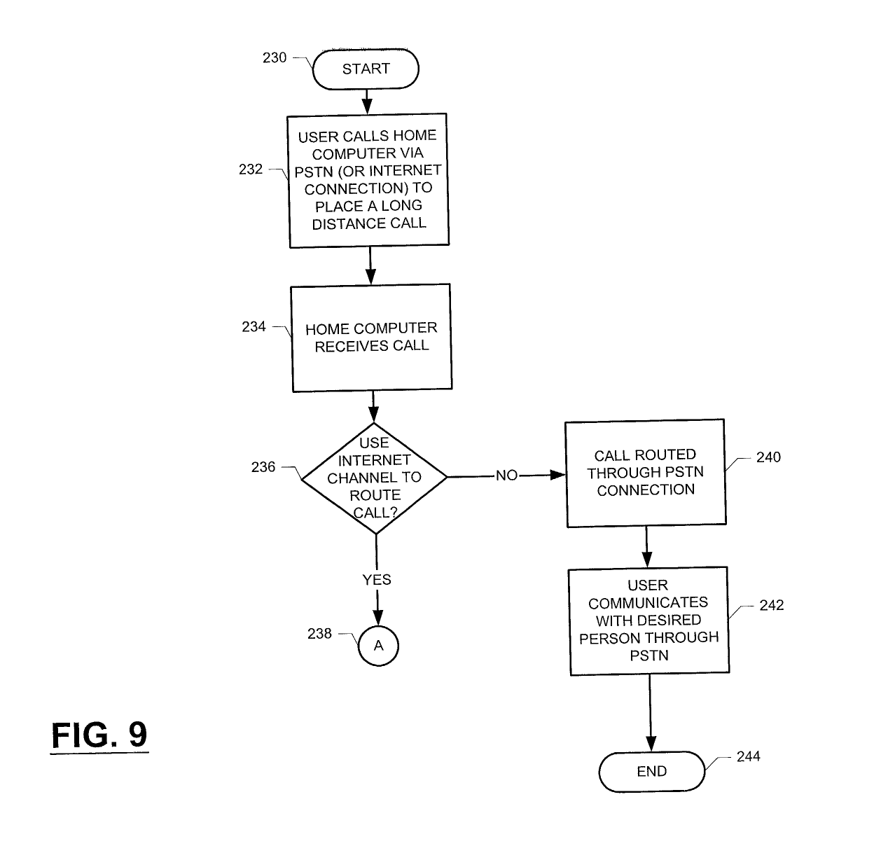

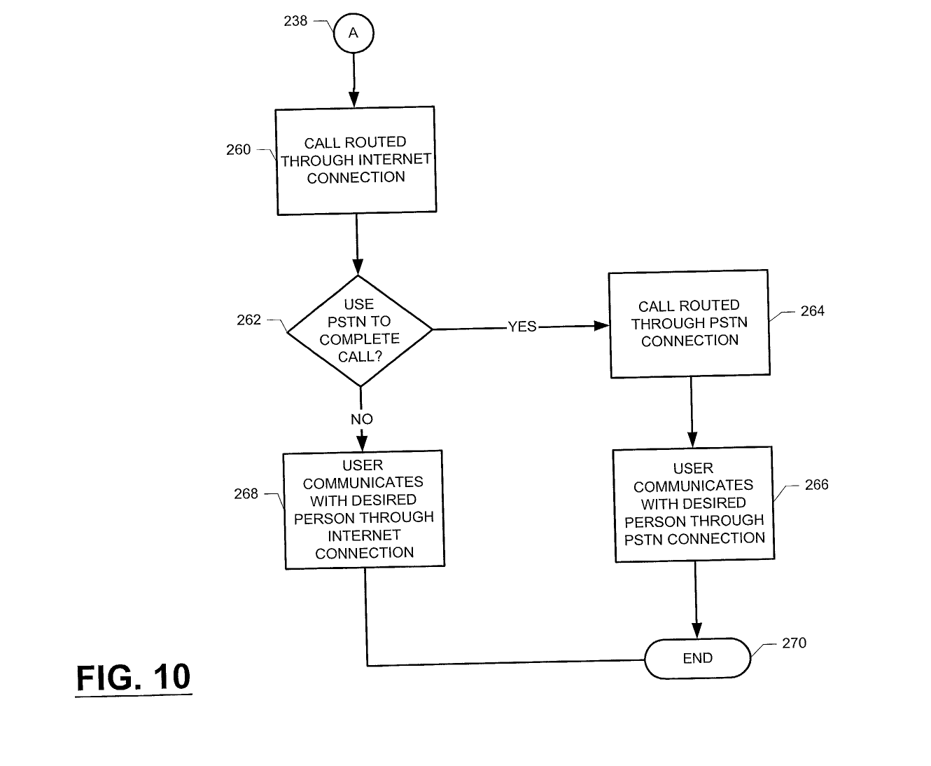

FIGS. 9 and 10 are flowcharts that depict the operational steps of the present invention for a user placing a phone call to another person through a PSTN connection and/or an Internet connection. Start indication block 230 indicates that processing begins at process block 232. At process block 232, a user calls the home computer over a PSTN or Internet connection. In this example, the user wishes to speak to another person located in a distant location (i.e., a “long distance” phone call).

The home computer receives the call at process block 234. Decision block 236 examines whether to use an Internet channel to route the call. The examination is based upon the location of the person with whom the user wishes to speak and a cost comparison between using an Internet connection to make the call versus a PSTN connection. If decision block 236 decides not to use an Internet channel to route the call, then processing continues at process block 240. At process block 240, the call is routed through a PSTN connection. At process block 242, the user communicates with the desired person through the PSTN connection. At the end of the call, processing terminates at end block 244. However, if decision block 236 decides to use an Internet channel to route the call, then processing continues at continuation block 238 on FIG. 10.

With reference to FIG. 10, the call is routed at process block 260 through an Internet connection to the remote location where the desired person is located. Decision block 262 examines whether a PSTN connection should be used to complete the call. The decision may be based upon whether the PSTN connection is less expensive to route the call to the desired person and whether the PSTN connection is the only viable channel to the desired person.

If a PSTN connection is to be used as determined by decision block 262, then process block 264 routes the call through the PSTN connection. At process block 266, the user communicates with the desired person through the PSTN connection. At the end of the call, processing terminates at end block 270.

If an Internet connection is to be used as determined by decision block 262, then process block 268 routes the call through an Internet connection, and the user communicates with the desired person through the Internet connection. At the end of the call, processing terminates at end block 270.

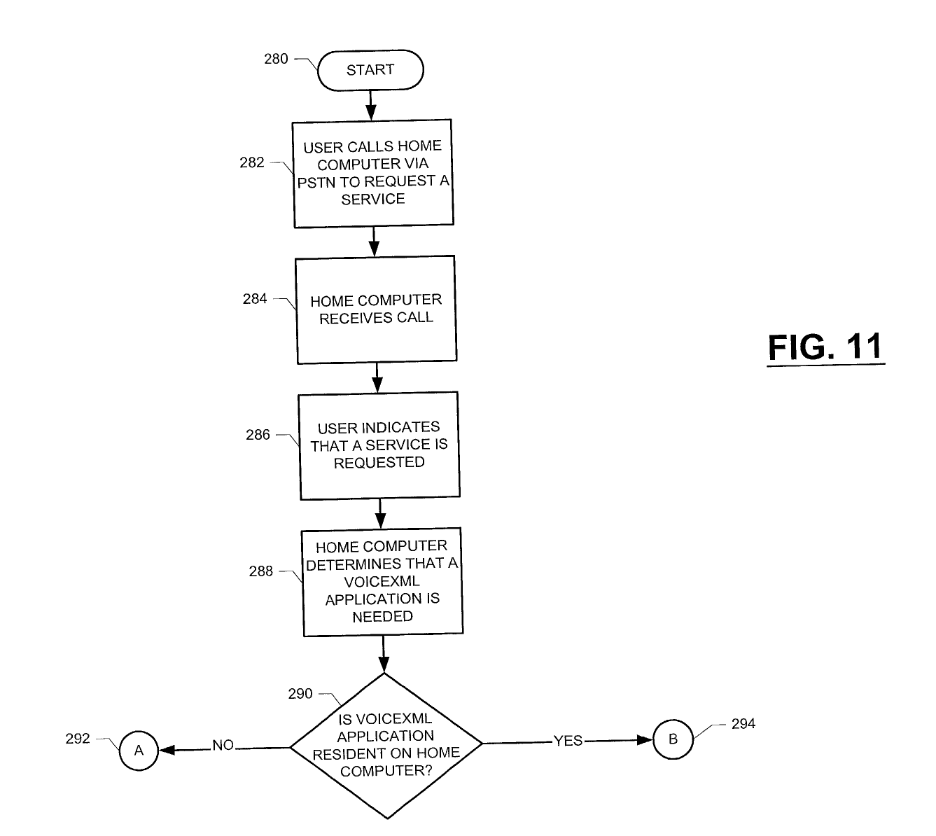

FIGS. 11-13 are flowcharts that depict the operational steps of the present invention handling a service request from a user. Start indication block 280 indicates that process block 282 is performed wherein a user calls the user's home computer over a PSTN connection in order to request a service (such as a restaurant location service). At process block 284, the home computer receives the call.

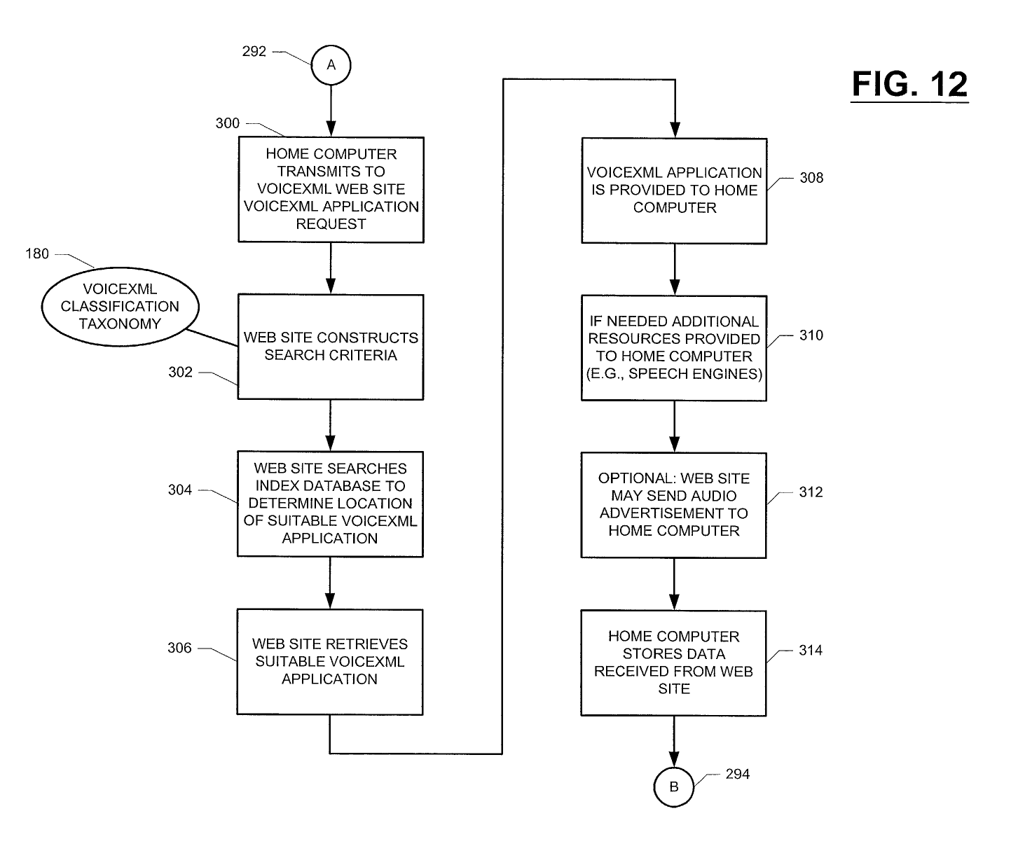

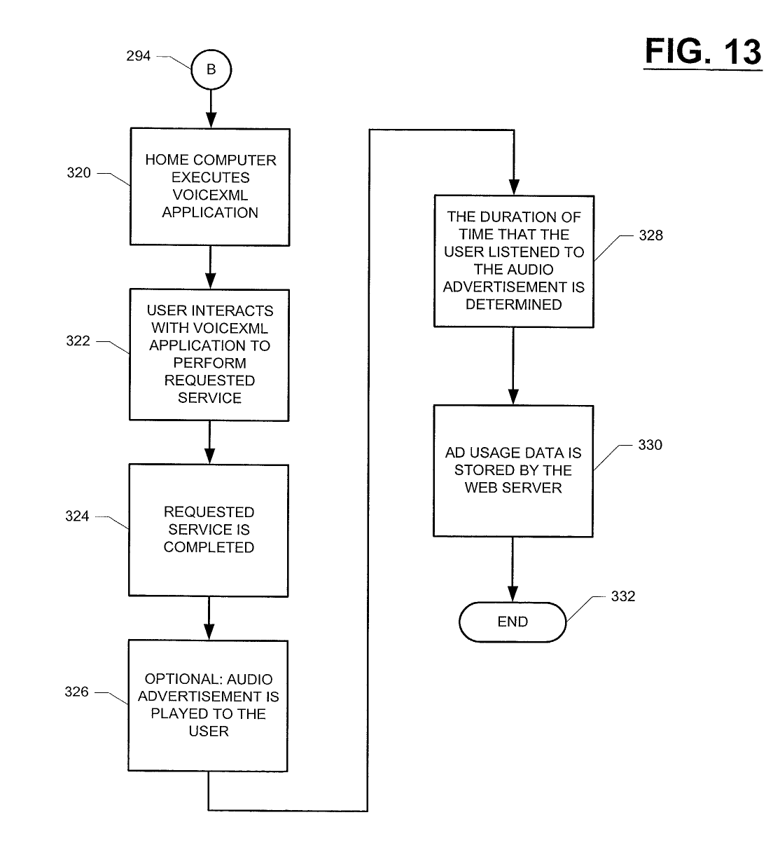

At process block 286, the user indicates the service that is desired. The home computer determines that a VoiceXML application is needed in order to provide the service. Decision block 290 examines whether the VoiceXML application is resident on the home computer. If it is resident, then processing continues on FIG. 13 at process block 320. However, if the VoiceXML application is not resident on the home computer, then processing continues on FIG. 12 at process block 300.

With reference to FIG. 12, the home computer transmits to the VoiceXML web site a VoiceXML application request at process block 300. The request contains search criteria so that the web site may search its database according to its VoiceXML classification taxonomy 180. Process block 302 constructs the search criteria in accordance with the VoiceXML classification taxonomy 180. The search criteria may for example contain the attributes of the home computer (such as what speech engines operate upon the home computer), the type of service requested, and other such criteria to retrieve a suitable voice application.

The search is performed at process block 304 in order to determine the location of a suitable VoiceXML application. Process block 306 retrieves a suitable VoiceXML application. An embodiment of the present invention includes retrieving the VoiceXML application from another web site. Another embodiment includes storing the VoiceXML application in the database.

At process block 308, the VoiceXML application is provided to the home computer. At process block 312, the web site may send an audio advertisement to the home computer. The audio advertisement sent to the home computer may have been selected based upon the profile of the user using the home computer. The home computer stores the data (e.g., the VoiceXML application and audio advertisement) on its storage medium (e.g., its random access memory, hard drive, etc.). Processing continues on FIG. 13 at process block 320.

With reference to FIG. 13, the home computer executes the VoiceXML application at process block 320. At process block 322, the user interacts with the VoiceXML application so that the requested service may be performed. The requested service is completed at process block 324. If an audio advertisement had been sent, then the audio advertisement is played to the user at process block 326. Process block 328 determines the duration of time that the user listened to the audio advertisement. At process block 330, this ad usage data is sent by the home computer to the web site which stores the data in its database. Processing terminates at end block 332.

The preferred embodiment described with reference to the drawing figures is presented only to demonstrate an example of the invention. Additional and/or alternative embodiments of the invention will be apparent to one of ordinary skill in the art upon reading this disclosure. For example, the present invention has been described in the context of a residential home. However, the computer of the present invention may also be used within a small office/home office (SOHO) context. In this way, the advantages of the present invention may be realized by providing valued functionality on a client-side computer.

It is claimed:

1. A home-based client-side media computer for use within a home that has a broadband connection to an Internet network, comprising:
a first connection port to allow a speech-based conversation to occur over the home-based broadband connection to the Internet network;
a second connection port to allow a speech-based conversation to occur over a public switched telephone network (PSTN); and
a plurality of speech engines that recognize speech and synthesize speech to allow the speech-based conversations to occur over the first connection port and the second connection port.

2. The home-based computer of claim 1 wherein a user connects to the home-based computer via the broadband connection in order to provide at least one home appliance voice command, said home-based computer further comprising:
an appliance control software module that controls at least one home appliance based upon the user's voice command.

3. The home-based computer of claim 2 wherein the user uses a wireless communication device to connect to the home-based computer in order to provide the home appliance voice command.

4. The home-based computer of claim 3 wherein a user connects to the home-based computer over the second connection port in order to provide at least one home appliance voice command, said home-based computer further comprising:
an appliance control software module that controls at least one home appliance based upon the user's voice command received over the second connection port.

5. The home-based computer of claim 4 wherein the user uses a plain telephone connected to the PSTN in order to provide the home appliance voice command over the second connection port.

6. The home-based computer of claim 1 wherein a user connects to the home-based computer via the broadband connection in order to provide at least one personal software application voice command, said home-based computer further comprising:
a personal software application retrieval module that retrieves personal information from a software application based upon the personal software application voice command of the user.

7. The home-based computer of claim 6 wherein the user uses a wireless communication device to connect to the home-based computer in order to provide the personal software application voice command.

8. The home-based computer of claim 7 wherein the software application is software selected from the group consisting of personal information management software, financial software, electronic mail software, and combinations thereof.

9. The home-based computer of claim 7 wherein a user connects to the home-based computer over the second connection port in order to provide at least one personal software application voice command, wherein the personal software application retrieval module controls at least one home appliance based upon the user's voice command received over the second connection port.

10. The home-based computer of claim 9 wherein the user uses a plain telephone connected to the PSTN in order to provide the home appliance voice command over the second connection port.

11. The home-based computer of claim 10 wherein the software application is software selected from the group consisting of personal information management software, financial software, electronic mail software, and combinations thereof.

12. The home-based computer of claim 1 wherein the computer operates within residential home of a user.

13. The home-based computer of claim 1 wherein the computer operates within SOHO environment.

14. The home-based computer of claim 1 wherein the computer operates within a non-Internet Service Provider environment.

15. The home-based computer of claim 1 wherein the first connection port provides for voice data over a VoIP channel.

16. The home-based computer of claim 1 wherein the first connection port provides for voice data over a VoN channel.

17. The home-based computer of claim 1 further comprising:
a voice markup language management module connected to the Internet network in order to retrieve a voice markup language program to interact by a speech-based conversation with the user over the first and second connections.

18. The home-based computer of claim 17 wherein the voice markup language management module communicates a voice application request to a voice application web site over the Internet, wherein the voice application web site provides a voice markup language program to the voice markup language management module.

19. The home-based computer of claim 18 wherein the provided voice markup language program interacts by a speech-based conversation with the user.

20. The home-based computer of claim 19 wherein the web site includes a database that stores the voice application data in accordance with a predetermined voice application taxonomy, wherein the web site retrieves voice application data based upon the voice application request from the voice markup language management module, wherein the retrieved voice application data is used to provide the voice markup language program to the voice markup language management module.

21. The home-based computer of claim 20 wherein the voice application request is based at least in part upon the voice application taxonomy.

22. The home-based computer of claim 21 wherein the voice application taxonomy includes classifications selected from the group consisting of required speech engine resources, required telephony resources, required telephony markup language, required application server environment, and combinations thereof.

23. The home-based computer of claim 20 wherein a plurality of audio advertisements is accessible by the web site, wherein at least one of the audio advertisements is retrieved and based upon predetermined selection rules, wherein the retrieved audio advertisement is played to the user.

24. The home-based computer of claim 23 wherein the request includes a user profile, wherein at least one of the audio advertisements that substantially matches the user profile is played to the user.

25. The home-based computer of claim 23 wherein the selection rules includes balanced ad usage rules that are used to determine which stored audio advertisement to retrieve.

26. The home-based computer of claim 1 further comprising:
a phone management module that handles calls from a user over the first and second connection ports in order to allow a speech-based conversation to occur with another user.

27. A home-based computer-implemented method for use within a home that has a connection to an Internet network, comprising the steps of:
communicating with a first communication device located on the Internet network so that a speech-based conversation can occur over the home-based connection to the Internet network;
communicating with a second communication device located on a public switched telephone network (PSTN) so that the speech-based conversation can occur over the public switched telephone network; and
recognizing speech and synthesizing speech to allow the speech-based conversation to occur over the Internet network and the public switched telephone network.

28. The home-based method of claim 27 wherein a user connects over the Internet network to the home-based computer via a broadband connection in order to provide at least one home appliance voice command, said home-based method further comprising the step of:
controlling at least one home appliance based upon the user voice command.

29. The home-based method of claim 28 wherein the user uses a wireless communication device to connect to the home-based computer in order to provide the home appliance voice command.

30. The home-based method of claim 27 wherein a user connects to the home-based computer via a broadband Internet network connection in order to provide at least one personal software application voice command, said home-based method further comprising the step of:
retrieving personal information from a software application based upon the personal software application voice command of the user.

31. The home-based method of claim 30 wherein the user uses a wireless communication device to connect to the home-based computer in order to provide the personal software application voice command.

32. The home-based method of claim 31 wherein the software application is software selected from the group consisting of personal information management software, financial software, electronic mail software, and combinations thereof.

33. The home-based method of claim 27 further comprising the step of:
retrieving a voice markup language program so that the speech-based conversation can occur.

34. The home-based method of claim 27 further comprising the step of:
retrieving from a remote database a voice application to manage the speech-based conversation.

35. The home-based method of claim 34 wherein data about the voice application is stored in the remote database based at least in part upon voice application taxonomy means.

36. The home-based method of claim 35 wherein the voice application taxonomy means includes classifications selected from the group consisting of required speech engine resources, required telephony resources, required telephony markup language, required application server environment, and combinations thereof.

37. The home-based method of claim 34 further comprising the step of:
playing an audio advertisement when a voice application is retrieved from the remote database in order to service a request from a user.

38. The home-based method of claim 27 wherein the first communication deviced is a cellular communication phone.

39. The home-based method of claim 27 wherein the first communication device is a remote computer that provides a telephony service.

40. The home-based method of claim 27 wherein the second communication device is a cellular communication phone.

41. The home-based method of claim 27 wherein the second communication device is a plain phone.
